(19) United States
(12) Patent Application Publication
(10) Pub. No.: US 2004/0227020 A1
(43) Pub. Date: Nov. 18, 2004

(54) Valve arrangement for spray dampening units on printing machines

(75) Inventors: Michael Baldy, Steinfurt (DE); Robert Holtwick, Telgte (DE)

Correspondence Address: RICHARD M. GOLDBERG, 25 EAST SALEM SREEET, SUITE 419, HACKENSACK, NJ, 07601, US

(73) Assignee: Technotrans AG, Sassenberg (DE)

(21) Appl. No.: 10/847,061

(22) Filed: May 17, 2004

(30) Foreign Application Priority Data
May 17, 2003 (DE) 103 22 320.7

(51) Int. Cl. B05B 1/30

(52) U.S. Cl. 239/574; 239/569

(57) ABSTRACT

A valve arrangement for spray dampening units on printing machines with a feeder system to supply the valve arrangement with pressurized dampening agent and spray nozzles downstream of the valve arrangement, includes two valves disposed behind each other with staggered opening times. In a first embodiment, the opening times are staggered so that both valves are only open at the same time for a small period of time. This means shorter effective opening times can be achieved than with individual valves. In a second embodiment there is an elastic buffer element between the two valves, and the opening times are completely staggered so that there are no common opening times. When the upstream valve is opened the buffer element generates an additional uptake of dampening agent, which is ejected by the buffer element when the first valve is closed and the downstream valve is opened.

This invention relates to a valve arrangement for spray dampening units on printing machines with at least one feeder system to supply the valve arrangement with pressurized dampening agent and at least one spray nozzle downstream of the valve arrangement.

In offset printing in particular, the surface of the printing plate is wetted with a dampening agent to prevent ink from adhering to the non-printing parts of the printing plate. The most commonly used dampening agents consist of water and a range of additives, e.g. up to 15% alcohol plus anticorrosive and antimicrobial substances, surfactants and such like.

Understandably, it is advantageous to ensure that the wetting of the printing plate surface can be controlled as precisely as possible. For this purpose, use is made of spray dampening units which extend parallel to the roller to be sprayed and have, directed at the roller, a row of spray nozzles which are supplied through separate valves with dampening agent from a dampening agent feeder system. The way in which the printing plate surface is wetted can be altered by adjusting the nozzles, the spray times, the administered volumes of dampening agent and the position of the spray nozzles relative to the printing plate surface etc.

In this context it has been shown that it is basically more cost-effective to administer the dampening agent in short bursts of low volumes than to supply larger volumes of dampening agent in one go. In practice, however, the options for shortening the opening times of conventionally marketed valves are limited. Even valve elements with very small masses cannot be moved speedily or precisely enough to reduce the opening and closing times to under 10 or even 5 milliseconds. With cycle times that short, the valve elements are unable to move into their full opening and closing positions.

The invention is therefore based on the task of creating a valve arrangement of the above-mentioned type, which allows extremely short opening times without giving rise to any noteworthy increase in costs.

This task is solved according to the invention by a valve arrangement characterised in that it comprises two valves disposed behind each other with staggered opening times.

According to a first embodiment of the invention the opening times are staggered in such a way that they partially overlap. The valve arrangement formed by two valves disposed behind each other only permits the passage of dampening agent during the time slot created by the overlapping. The overlap time can be set to as short as desired without having to have very short and then, for technical reasons, impossibly short opening times of the two valves. The advantage of being able to administer very short spray pulses is a significant improvement in the precision of the dampening agent application process.

In a second embodiment, the opening times of both valves are completely staggered so that there is no overlapping of opening times, and there is an elastic buffer element between the two valves. This buffer element can be formed by a connecting tube, an elastic seal located in the system, a membrane pressure accumulator or such like. In this embodiment, the buffer is “tensioned” by opening the upstream valve and, when the downstream valve is opened, the excess volume taken up by the tensioning of the buffer is ejected. By choosing a buffer with an appropriate accumulator volume, it is possible to determine to a high degree the volume that is subsequently ejected.

Examples of preferred embodiments will be described in more detail below with reference to the enclosed drawings.

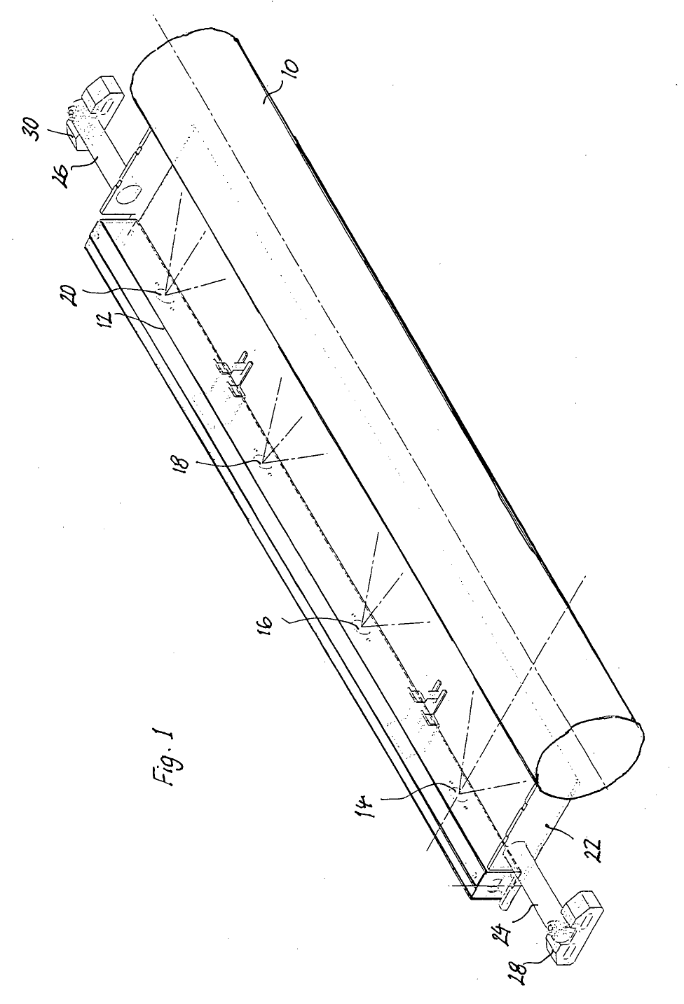

FIG. 1 is a diagrammatic perspective view of a typical spray bar for dampening units of the present type;

FIG. 2 is a diagrammatic view of a first embodiment of a valve arrangement according to the invention;

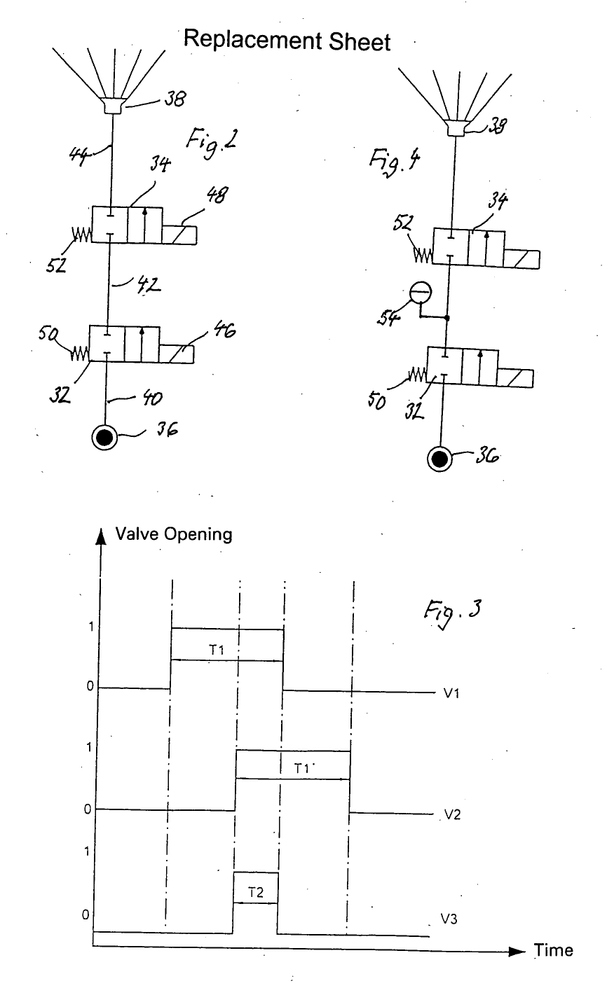

FIG. 3 is a time diagram showing the functioning of the valve arrangement of FIG. 2;

FIG. 4 is a diagrammatic representation to explain the functioning of a second embodiment of the invention.

In FIG. 1, a printing roller is designated as 10. Parallel to printing roller 10 there is a spray beam 12, which carries a plurality of spray valves 14,16,18, 20. The spray valves are directed into a spray box 22 which is open towards printing roller 10 in a manner not shown, and creates a certain lateral limitation of the individual spray cones, but, above all, prevents spray mist from drifting around in the vicinity of the printing machine. The top cover of spray box 22 has been omitted from the drawing for the sake of clarity. Spray beam 12 is attached to spray box 22. Attached to both ends of spray box 22 there are axis stumps 24,26, with the aid of which the spray box is held in bearing bases 28,30. Spray beam 12 can be adjusted vertically, in the direction of the nozzles and with respect to the gap between the nozzles and printing roller 10 etc. The spray nozzles can also be made in some suitable way so that they can be adjusted, and the valves not shown in FIG. 1 can be opened and closed in line with various time programs.

FIG. 2 shows a first embodiment of a valve arrangement according to the invention. This valve arrangement comprises two valves 32,34 disposed behind each other, which are supplied with pressurized dampening agent from a dampening agent source 36. There is a spray nozzle 38 on the other side of the valve arrangement.

The dampening agent source 36 and the first valve 32, this first valve 32 and second valve 34, and finally the second valve 34 and spray nozzle 38 are connected by pipe sections 40,42,44.

The valves 32,34 shown are opened by electromagnets 46,48 and closed by return springs 50,52. Other embodiments of valves may also be used.

FIG. 3 shows the way in which the opening and closing of valves 32,34 is controlled. Curve V1 illustrates the opening control of valve 32, and curve V2 shows the opening control of the second valve 34. It can be seen that both valves 32,34 are each opened for the duration T1, although this takes place in a staggered format in such a way that they are only open both together for the duration T2. It is only for this shorter duration T2 that there is an uninterrupted connection from dampening agent source 36 to spray nozzle 38. In this way it is possible to achieve a shorter opening time, even though valves are used whose valve mechanism does not permit such short opening times.

FIG. 4 shows a valve arrangement according to a second embodiment of the invention. FIG. 4 largely coincides with FIG. 2, but differs from FIG. 2 in that an elastic buffer device is provided in the vicinity of the connection between the two valves 32,34, i.e. pipe section 42. This is symbolised by a pressure accumulator 54 connected to pipe section 42. It is not necessary, however, to use a pressure accumulator of this type. Pipe section 42 may have a certain elasticity itself, or elastic sealing elements or such like can be envisaged in the vicinity of the connections to both valves.

A further difference with regard to the embodiment of FIG. 2 is that both the valves 32,34 of FIG. 4 are opened and closed completely independently of each other. There is no period of time during which both valves are open at the same time. When the first valve 32 is open, the elastic buffer device in the vicinity of the connecting pipe between the valves is tensioned by the pressure of the incoming dampening agent. When the first valve is then shut and the second valve is opened, this pressure can dissipate in the direction of spray nozzle 38.

By an appropriate choice of the elastic buffer device it is possible to generate a short spray pulse whose length and intensity, and whose volume of dampening agent in particular, can be adjusted by trial and calculation.

Both valves 32,34, and possibly pressure accumulator 54, can also be connected to form one unit.

What is claimed is:

1. Valve arrangement for spray dampening units on printing machines with at least one feeder system to supply the valve arrangement with pressurized dampening agent and at least one spray nozzle downstream of the valve arrangement, the valve arrangement comprising two valves disposed behind each other with staggered opening times.

2. The valve arrangement of claim 1, wherein the valves have partially overlapping opening times, and an overlap time is shorter than a shortest possible opening time of the two valves.

3. The valve arrangement of claim 1, wherein the opening times of the valves are completely staggered with no overlap, and further comprising an elastic buffer connected between the valves.

4. The valve arrangement of claim 3, wherein the elastic buffer is formed by an elastic connecting pipe.

5. The valve arrangement of claim 3, wherein the elastic buffer is formed by elastic sealing elements in a connection between the valves.

6. The valve arrangement of claim 3, wherein the elastic buffer is formed by a pressure accumulator in a connecting pipe between the valves.
